(19) United States
(12) Patent Application Publication
(10) Pub. No.: US 2002/0024464 A1
(43) Pub. Date: Feb. 28, 2002

(54) Land surveying apparatus and method of use thereof

(75) Inventors: Barbara A. Kovell, Uniontown, PA (US); Shawn E. Johnson, Farmington, PA (US)

Correspondence Address: Randall A. Notzen, Webb Ziesenheim Logsdon Orkin & Hanson, P.C., 700 Koppers Buildings, 436 Seventh Avenue, Pittsburgh, PA, 15219-1818, US

(73) Assignee: Sun-Lab Technology, Inc.

(21) Appl. No.: 09/862,841

(22) Filed: May 22, 2001

Related U.S. Application Data
(60) Provisional application No. 60/227,247, filed on Aug. 23, 2000.

(51) Int. Cl. G01S 5/14

(52) U.S. Cl. 342/357.14; 342/357.17

(57) ABSTRACT

A land surveying apparatus for real-time acquisition of earth position data and land distance data includes a distance measuring instrument, a GPS receiver, a controller and a memory coupled to a land vehicle. The distance measuring instrument receives input regarding a distance the land vehicle travels on the land and outputs land distance data regarding the distance. The GPS receiver receives GPS signals and outputs earth position data regarding a position of the GPS receiver on the surface of the earth as a function of the received GPS signals. The controller generates a plurality of sample intervals, and acquires for each sample interval the earth position data output by the GPS receiver and the land distance data output by the distance measuring instrument. The controller relates the land distance data and the earth position data as a function of the corresponding sample interval and stores in a memory for each sample interval the corresponding earth position data and land distance data.

### CROSS REFERENCE TO RELATED APPLICATION

This application claims priority from U.S. Provisional Patent Application Ser. No. 60/227,247, filed Aug. 23, 2000, entitled “Road Distance Measurement System With Integrated Global Positioning System and Method of Use Thereof”.

### BACKGROUND OF THE INVENTION

1. Field of the Invention

The present invention relates to an automated method of land surveying using a global positioning system (GPS) and a distance measuring instrument (DMI) technology. In particular, the present invention discloses a land surveying apparatus for real-time acquisition of earth position data and land distance data.

2. Background Art

A global positioning system (GPS) is a satellite-based radio position system that is capable of providing three-dimensional position and time information to a GPS receiver. In a manner known in the art, the GPS receiver converts the position information into earth position data, which includes longitude, latitude, and preferably altitude. From this earth position data, a user of a GPS receiver can pinpoint his location anywhere on the surface of the earth. A GPS operated by the United States Department of Defense is the first GPS widely available to the civilian community.

Each GPS receiver is limited in its capacity to detect its precise location on the surface of the earth due to common error. The greatest common error that affects the accuracy of a GPS receiver to precisely detect its location is changing conditions in the ionosphere which affect the propagation of satellite signals to the GPS receiver. To improve the accuracy of the earth position data output by a GPS receiver, a differential global positioning system (DGPS) was created. The DGPS eliminates the common error in a GPS receiver by use of a reference GPS receiver (known as a base station) positioned at an absolute known position on the surface of the earth. The difference between this known earth position and the earth position data determined by the base station is the common error. This common error can be transmitted as an error correction radio beacon signal to GPS receivers in a local area to improve the accuracy of the earth position data output by these GPS receivers. More specifically, the base station transmits an error correction radio beacon signal to each GPS receiver equipped with a radio beacon receiver which extracts from the error correction radio beacon signal error correction data, and combines this error correction data with earth position data extracted from the received GPS signals to obtain corrected earth position data.

Mapping and surveying companies use GPS extensively for geolocating and mapping features such as power lines, rivers, highways, crops, or soil types. However, GPS is not sufficiently accurate by itself for land distance measurements.

A distance measuring instrument (DMI) is capable of measuring land distance as well as speed. However, it is often necessary for various maintenance, planning, and construction projects, such as highway construction projects, power utilities layouts, postal and school bus routes with depicted stops, to correlate land distance measurements taken along a path with earth position data acquired along the path. Maps worldwide often use coordinate grids and topography based on photogrametric surveys that were last carried out many years ago. However, many areas are often not surveyed as accurately or as recently as needed for various projects. The main problem is to record and/or plot to existing maps the distance measurement data to which the GPS earth position data refers. A separate GPS receiver and a separate DMI in a land vehicle could be utilized to overcome the above problem, but their use would be very time-consuming. Specifically, the land vehicle would have to start and stop each time in order for a user in the land vehicle to record the earth position data output by the GPS receiver and the land distance measurement data output by the DMI for the particular earth position. Moreover, the accuracy of the map with respect to the associated ground coordinates is decreased when the land vehicle travels greater distances between stops.

It is therefore, an object of the present invention to overcome the above problems and others by providing a land surveying apparatus for recording and/or plotting land distance measurement data and earth position data to existing maps.

Still other objects of the present invention will become apparent to those of ordinary skill in the art upon reading and understanding the following detailed description.

### SUMMARY OF THE INVENTION

Accordingly, we have invented a land surveying apparatus for real-time acquisition of earth position data and land distance data. The apparatus includes a distance measuring instrument coupled to a land vehicle. The distance measuring instrument is configured to receive input regarding a distance the land vehicle travels on the land and to output land distance data regarding the distance. A GPS receiver is coupled to the land vehicle. The GPS receiver is configured to receive GPS signals and to output earth position data regarding a position of the GPS receiver on the surface of the earth as a function of the received GPS signals. A controller generates a plurality of sample intervals. For each sample interval, the controller acquires the earth position data output by the GPS receiver and the land distance data output by the distance measuring instrument and relates the land distance data and the earth position data as a function of the corresponding sample interval. A memory is coupled to the controller for storing for each sample interval the corresponding earth position data and land distance data.

A display can be coupled to the controller. The controller can cause the display to display a map that includes, for each of one or more sampled intervals, indicia corresponding to at least one of the earth position data and the land distance data for the sample interval, with each indicia located on the map as a function of the earth position data for the sample interval.

Each indicia is located on the map at a map coordinate position corresponding to an earth coordinate position determined from the earth position data for the sample interval. The map can further include for each of one or more indicia at least one of the land distance data and the earth position data for the sample interval displayed adjacent the corresponding indicia. A casing can house the distance measuring instrument, the GPS receiver, the controller, the memory, and an alpha-numeric display coupled to the controller.

The distance measuring instrument can also output speed data regarding a measured speed of the land vehicle traveling on the land. The controller can cause the alpha-numeric display to display at least one of the distance the land vehicle travels and the speed of the land vehicle traveling on the land.

The land surveying apparatus can also include a radio beacon receiver configured to receive an error correction radio beacon signal and to output error correction data to the GPS receiver as a function thereof. The GPS receiver acquires the error correction data output from the radio beacon receiver and combines the error correction data and the earth position data from the received GPS signals to obtain corrected earth position data corresponding to a position of the GPS receiver on the earth's surface.

The radio beacon receiver can be housed within the casing, and the memory can include a removable memory module.

We have also invented a land surveying apparatus for real-time acquisition of earth position data and land distance data that includes a distance measuring instrument and a GPS receiver coupled to a land vehicle. The distance measuring instrument determines a distance the land vehicle travels on the land and outputs land distance data corresponding to the distance. The GPS receiver is configured to receive GPS signals and to output as a function of the GPS signals received for each of a plurality of positions of the land vehicle on the land waypoint data. Each waypoint data includes at least two of a longitude, latitude and altitude of the land vehicle on the land. A controller generates a plurality of sample intervals and acquires for each sample interval the waypoint data output by the GPS receiver and the land distance data output by the distance measuring instrument. The controller relates for each sample interval the acquired waypoint data and land distance data. A memory is coupled to the controller for storing for each sample interval the acquired waypoint data and land distance data.

The land surveying apparatus can include a radio beacon receiver configured to receive an error correction radio beacon signal and to output error correction data to the GPS receiver as a function thereof. The GPS receiver acquires the error correction data output from the radio beacon signal and combines the error correction data with the waypoint data from the received GPS signals to obtain corrected waypoint data corresponding to a position of the GPS receiver on the earth's surface.

Preferably, the controller generates a sample interval at least every one second.

Lastly, we have invented a method of land surveying that includes the steps of: providing a system having a distance measuring instrument (DMI) and a global positioning system (GPS) receiver connected to a controller; traveling along a path with the system; causing the controller to generate a plurality of sample intervals; acquiring for each sample interval earth position data output by the GPS receiver and land distance data output by the DMI; relating for each sample interval the acquired earth position data and the acquired land distance data; storing in a memory coupled to the controller for each sample interval the acquired earth position data and the acquired land distance data; and displaying the stored earth position data and/or the stored land distance data on a display coupled to the controller, wherein the controller causes the display to display a map that includes, for each of one or more sample intervals, indicia corresponding to at least one of the earth position data and land distance data for the sample interval. Each indicia displayed on the map is located at a map coordinate position corresponding to an earth coordinate position determined from the earth position data for the sample interval.

### BRIEF DESCRIPTION OF THE DRAWINGS

FIG. 1 is a plan view of an automobile including a land surveying apparatus in accordance with the present invention;

FIG. 2 is a block diagram of the land surveying apparatus of FIG. 1 including a display;

FIG. 3 is a plan view of a roadway with the automobile of FIG. 1 traveling thereon while the land surveying apparatus collects earth position data and land distance measurement data; and

FIG. 4 is a view of the display of FIG. 3 including map data thereon.

### DETAILED DESCRIPTION OF THE PREFERRED EMBODIMENTS

The invention will be described with reference to the accompanying Figures where like reference numbers correspond to like elements.

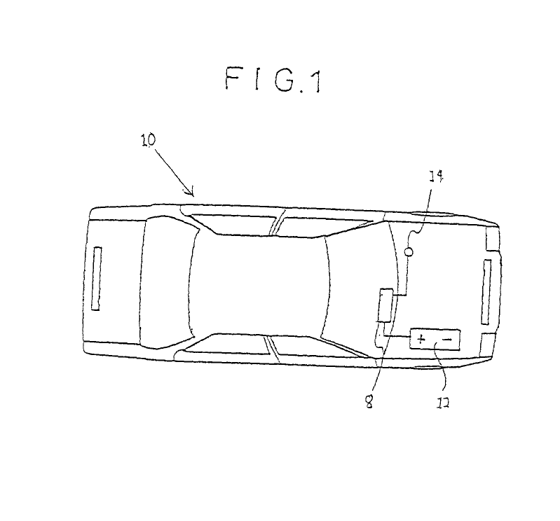

With reference to FIG. 1, a land surveying apparatus 8 is coupled to a land vehicle 10, e.g., an automobile, which is configured to travel on the surface of the earth. Land surveying apparatus 8 is powered by a battery 12 of land vehicle 10. Land surveying apparatus 8 is also connected to speedometer 14 of land vehicle 10.

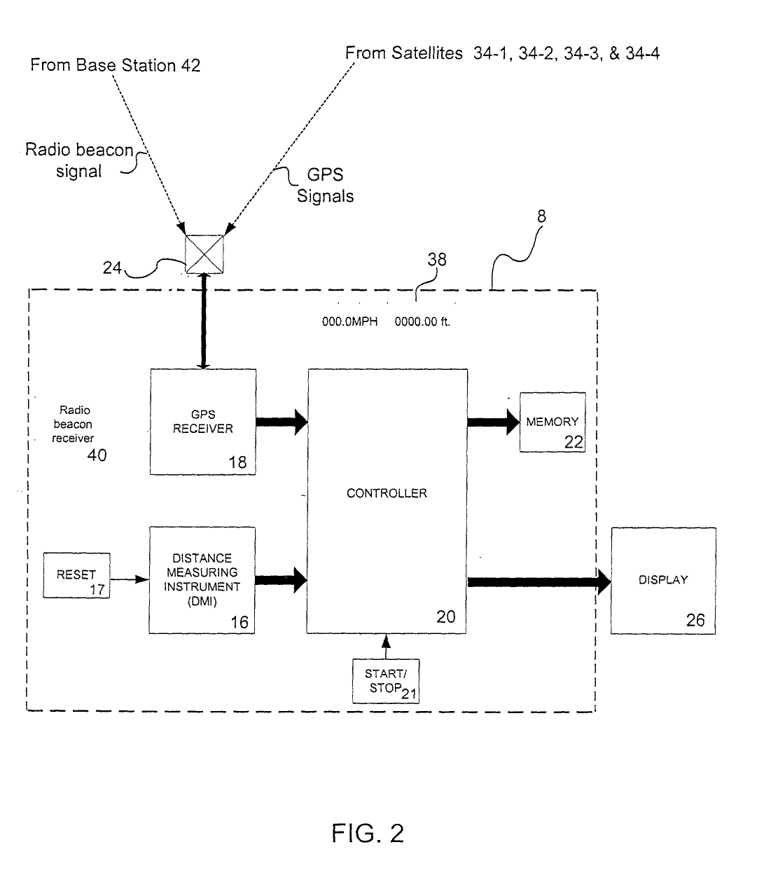

With reference to FIG. 2, land surveying apparatus 8 includes a distance measuring instrument (DMI) 16 and a GPS receiver 18 connected to a controller 20 which is connected to a memory 22.

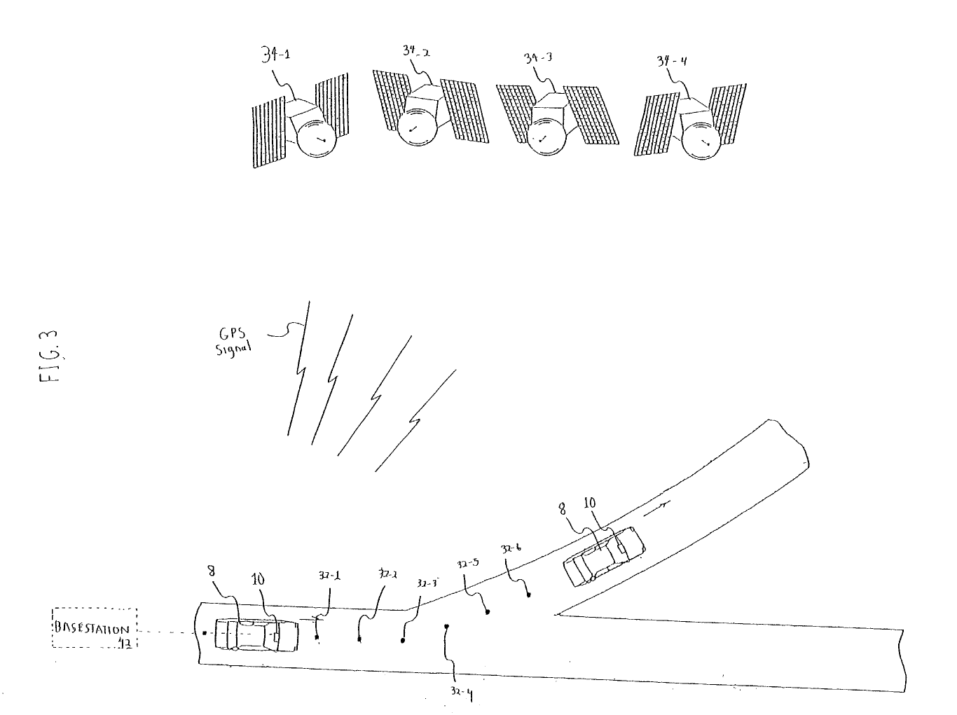

DMI 16 includes a reset 17 and controller 20 includes a start/stop button 21. GPS receiver 18 has an antenna 24 which receives GPS signals from satellites 34-1, 34-2, 34-3 and 34-4, shown in FIG. 3. GPS receiver 18 receives GPS signals from antenna 24 and outputs earth position data related to a position of GPS receiver 18 on the surface of the earth. DMI 16 determines the actual distance land vehicle 10 travels on the land from the mechanical or electrical input to speedometer 14 and continuously outputs land distance data related to this distance.

Controller 20 generates a plurality of sample intervals, preferably one every second. For each sample interval, controller 20 acquires earth position data output by GPS receiver 18 and land distance data output by DMI 16. Under the control of controller 20, memory 22 stores for each sample interval the acquired earth position data and land distance data. Preferably, memory 22 includes a removable memory module.

With reference to FIG. 3, GPS receiver 18 is configured to receive GPS signals from satellites 34-1, 34-2, 34-3 and 34-4 positioned in outer space. At least four satellites 34-1, 34-2, 34-3 and 34-4 must generate GPS signals in order for GPS receiver 18 to determine its three-dimensional position on the earth's surface. This three-dimensional position includes longitude, latitude and altitude. If only three satellites, e.g., 34-1, 34-2 and 34-3, generate GPS signals, GPS receiver 18 can only determine its two-dimensional position on the earth's surface. This two-dimensional position includes longitude and latitude.

In use of land surveying apparatus 8, GPS receiver 18 preferably determines its three-dimensional position when land vehicle 10 is traveling on the land. More specifically, GPS signals from satellites 34-1, 34-2, 34-3 and 34-4 are received by GPS receiver 18 which outputs, as a function of the received GPS signals, earth position data relating to each of a plurality of earth coordinate positions 32-1, 32-2, 32-3, 32-4, 32-5 and 32-6 of land vehicle 10 on the land. Preferably, GPS receiver 18 outputs earth position data or waypoint data related to each earth coordinate position 32-1, 32-2, 32-3, 32-4, 32-5 and 32-6 of land vehicle 10, preferably every one second. Earth position data includes at least two of a longitude, latitude and altitude of land vehicle 10 on the land.

When land vehicle 10 travels on the land, controller 20 periodically, e.g., once every second, acquires from GPS receiver 18 earth position data related to earth coordinate positions 32-1, 32-2, 32-3, 32-4, 32-5 and 32-6 of land vehicle 10 on the land. Since land vehicle 10 can travel a curved path on the land, the acquired earth position data segments the actual distance through the curve. Therefore, the acquired earth position data cannot be utilized to accurately determine the actual distance land vehicle 10 travels for the related earth coordinate positions 32-1, 32-2, 32-3, 32-4, 32-5 and 32-6. Moreover, because land vehicle 10 can vary in speed as it travels on the land, i.e., in a straight line and/or on a curve, the distance between adjacent earth coordinate positions 32-1, 32-2, 32-3, 32-4, 32-5 and 32-6 can vary, thereby providing further difficulty in determining the actual distance traveled by land vehicle 10 between adjacent earth coordinate positions 32-1, 32-2, 32-3, 32-4, 32-5 and 32-6. To overcome the problem of determining from the acquired earth position data the actual distance land vehicle 10 travels for the related earth coordinate positions 32-1, 32-2, 32-3, 32-4, 32-5 and 32-6, land surveying apparatus 8 includes DMI 16 which determines the actual distance land vehicle 10 travels on the land from the input to speedometer 14 and continuously outputs land distance data related to this distance.

In use of land surveying apparatus 8, a survey of a path is initiated when start/stop button 21 is first pressed. Thereafter, controller 20 periodically, e.g., every one second, acquires earth position data output by GPS receiver 18 and land distance data output by DMI 16 and stores the acquired earth position data and land distance data in memory 22. When start/stop button 21 is subsequently pressed a second time, controller 20 terminates acquiring and storing earth position data and land distance data. More specifically, reset 17 is activated at a starting earth coordinate position 32-1 to reset the land distance data output by DMI 16 to zero. Then, start/stop button 21 is pressed at starting earth coordinate position 32-1 and controller 20 acquires the earth position data and land distance data output by GPS receiver 18 and DMI 16, respectively, for a first sample interval and stores this data in memory 22. Thereafter, land vehicle 10 travels from earth coordinate position 32-1 to earth coordinate position 32-2 where controller 20 acquires the earth position data and land distance data output by GPS receiver 18 and DMI 16, respectively, for a second sample interval and stores this data in memory 22. The land distance data output by DMI at earth coordinate position 32-2 indicates the distance land vehicle 10 has traveled from the starting earth coordinate position 32-1. Similarly, for each subsequent sample interval, controller 20 acquires the earth position data and land distance data for the corresponding earth coordinate position, e.g., 32-3, 32-4, 32-5 and 32-6, and stores this data in memory 22 for later retrieval and/or analysis. When land vehicle 10 has traveled the path to be surveyed, start/stop button 21 is pressed a second time, which causes controller 20 to terminate acquisition and storage of data.

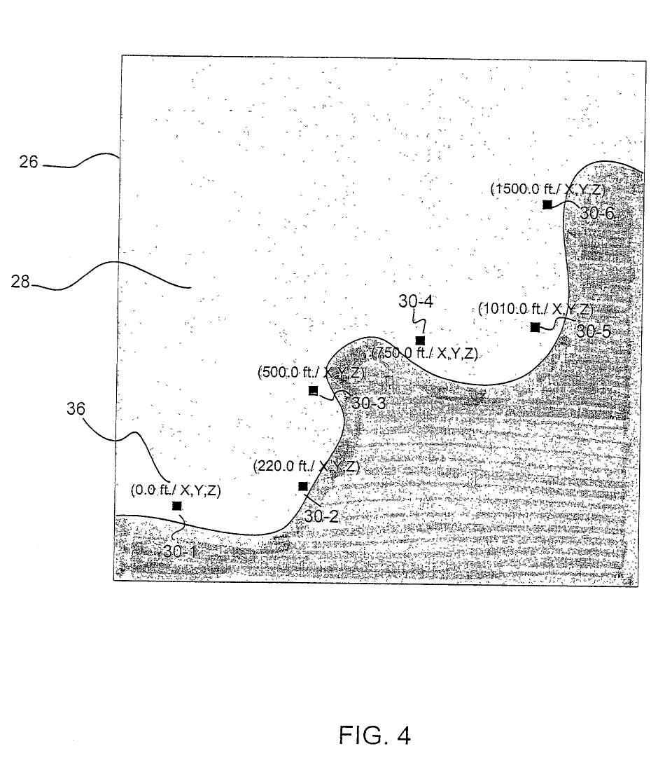

With reference to FIG. 4 and with continuing reference to FIGS. 2 and 3, land surveying apparatus 8 has a display 26 coupled to controller 20. Display 26 can be a printer, a plotter, an electronic display, or preferably, a video display. Controller 20 causes display 26 to display a map 28 which includes, for each of one or more sample intervals, indicia 30 located on map 28 at a position corresponding to the earth position data and/or the land distance data stored in memory 22 for the sample interval. Map 28 further includes for each of one or more indicia 30-1, 30-2, 30-3, 30-4, 30-5 and 30-6, the land distance data and/or earth position data for the sample interval displayed adjacent to the corresponding indicia 30-1, 30-2, 30-3, 30-4, 30-5 and 30-6. It should be appreciated that each indicia 30-1, 30-2, 30-3, 30-4, 30-5 and 30-6 is located at a position on map 28 corresponding to earth coordinate positions 32-1, 32-2, 32-3, 32-4, 32-5 and 32-6 determined from the acquired earth position data for the corresponding sample interval.

In use, real-time recording of a survey can be done with display 26 coupled to controller 20. For example, reset 17 is activated at starting earth coordinate position 32-1 to reset the land distance data output by DMI 16 to zero. Then, start/stop button 21 is pressed at starting earth coordinate position 32-1 to initiate a survey. Controller 20 causes display 26 to display map 28 having indicia 30-1 located at a position on map 28 corresponding to the starting earth coordinate position 32-1. The distance land vehicle 10 has traveled at starting earth coordinate position 32-1, e.g., 0.0 ft, and the longitude (X), latitude (Y) and altitude (Z) of starting earth coordinate position 32-1, determined from the GPS signals received by GPS receiver 18 at earth coordinate position 32-1, are displayed adjacent to indicia 30-1. Thereafter, as land vehicle 10 travels from earth coordinate position 32-1 to earth coordinate position 32-2, the land distance data output by DMI 16 is related to the distance land vehicle 10 travels between earth coordinate position 32-1 and 32-2. Controller 20 then causes display 26 to display indicia 30-2 located at a position on map 28 corresponding to earth coordinate position 32-2. Preferably, displayed adjacent indicia 30-2 is the land distance data output by DMI 16 relating to the distance land vehicle 10 travels between earth coordinate position 32-1 and 32-2, and the longitude (X), latitude (Y) and altitude (Z) of earth coordinate position 32-2 output by GPS receiver 18 at earth coordinate position 32-2. Similarly, controller 20 causes display 26 to display indicia 30-3, 30-4, 30-5 and 30-6, distance, latitude and altitude data corresponding to earth coordinate positions 32-3, 32-4, 32-5 and 32-6 respectively.

With reference back to FIG. 2, land surveying apparatus 8 can also include an alphanumeric display 38, shown in phantom, coupled to controller 20. Along with outputting land distance data, DMI 16 can also output speed data regarding a measured speed of land vehicle 10 traveling on the land. Controller 20 can acquire the speed data output by DMI 16 and can cause alphanumeric display 38 to display the distance land vehicle 10 travels and the speed of land vehicle 10 traveling on the land. Preferably, land surveying apparatus 8 includes a single casing for housing DMI 16, GPS receiver 18, controller 20, memory 22, and alphanumeric display 38.

Land surveying apparatus 8 can also implement a real-time differential GPS (DGPS) by including a radio beacon receiver 40, shown in phantom in FIG. 2, coupled to GPS receiver 18. Radio beacon receiver 40 is configured to receive radio beacon signals from a base station 42, shown in phantom in FIG. 3, via antenna 24. DGPS eliminates a common error in GPS receiver 18 by use of radio beacon signals transmitted to GPS receiver 18 from base station 42 positioned at an absolute or reference position on the surface of the earth. The difference between this reference position and the earth position data determined by base station 42 from the GPS signals received by base station 42 from satellites 34-1, 34-2, 34-3 and 34-4 is the common error. In operation, radio beacon receiver 40 receives error correction radio beacon signals from base station 42 via antenna 24 and outputs error correction data. GPS receiver 18 receives error correction data output from radio beacon receiver 40 and combines this error correction data with earth position data extracted from the GPS signals received by antenna 24 directly from satellites 34-1, 34-2, 34-3 and/or 34-4 to obtain corrected earth position data. GPS receiver 18 then outputs this corrected earth position data or corrected waypoint data which is related to a position of GPS receiver 18 on the surface of the earth. Controller 20, DMI 16, memory 22, alphanumeric display 38 and display 26 continue to operate as previously discussed using the more accurate or corrected earth position data. Preferably, land surveying apparatus 8 utilizing DGPS includes a single casing for housing radio beacon receiver 40, DMI 16, GPS receiver 18, controller 20, memory 22, and alphanumeric display 38.

The invention has been described with reference to the preferred embodiments. Obvious modifications and alterations will occur to others upon reading and understanding the preceding detailed description. It is intended that the invention be construed as including all such modifications and alterations insofar as they come within the scope of appended claims or the equivalents thereof.

We claim:

1. A land surveying apparatus for real-time acquisition of earth position data and land distance data, the apparatus comprising:
a distance measuring instrument coupled to a land vehicle, the distance measuring instrument configured to receive input regarding a distance the land vehicle travels on the land and to output land distance data regarding the distance;
a GPS receiver coupled to the land vehicle, the GPS receiver configured to receive GPS signals and to output earth position data regarding a position of the GPS receiver on the surface of the earth as a function of the received GPS signals;
a controller which generates a plurality of sample intervals, which for each sample interval acquires the earth position data output by the GPS receiver and the land distance data output by the distance measuring instrument, and which relates the land distance data and the earth position data as a function of the corresponding sample interval; and
a memory coupled to the controller for storing for each sample interval the corresponding earth position data and land distance data.

2. The land surveying apparatus as set forth in claim 1, further including a display coupled to the controller, wherein the controller causes the display to display a map that includes for each of one or more sample intervals indicia corresponding to at least one of the earth position data and the land distance data for the sample interval, with each indicia located on the map as a function of the earth position data for the sample interval.

3. The land surveying apparatus as set forth in claim 2, wherein each indicia displayed on the map is located at a map coordinate position corresponding to an earth coordinate position determined from the earth position data for the sample interval.

4. The land surveying apparatus as set forth in claim 2, wherein the map further includes, for each of one or more indicia, at least one of the land distance data and the earth position data for the sample interval displayed adjacent the corresponding indicia.

5. The land surveying apparatus as set forth in claim 1, further including a casing for housing the distance measuring instrument, the GPS receiver, the controller, the memory and an alphanumeric display coupled to the controller.

6. The land surveying apparatus as set forth in claim 5, wherein the distance measuring instrument further outputs speed data regarding a measured speed of the land vehicle traveling on the land.

7. The land surveying apparatus as set forth in claim 6, wherein the controller causes the alphanumeric display to display at least one of the distance the land vehicle travels and the speed of the land vehicle traveling on the land.

8. The land surveying apparatus as set forth in claim 1, further including a radio beacon receiver, the radio beacon receiver configured to receive an error correction radio beacon signal and to output error correction data to the GPS receiver, the GPS receiver acquiring the error correction data output from the radio beacon receiver and combining the error correction data with the earth position data from the received GPS signals to obtain corrected earth position data corresponding to a position of the GPS receiver on the earth's surface.

9. The land surveying apparatus as set forth in claim 5, further including a radio beacon receiver housed within the casing.

10. The land surveying apparatus as set forth in claim 1, wherein the memory includes a removable memory module.

11. A land surveying apparatus for real-time acquisition of earth position data and land distance data, the apparatus comprising:
a distance measuring instrument coupled to a land vehicle, with the distance measuring instrument determining a distance the land vehicle travels on the land and outputing land distance data corresponding to the distance;
a GPS receiver coupled to the land vehicle, the GPS receiver configured to receive GPS signals and to output as a function of the GPS signals received for each of a plurality of positions of the land vehicle on the land waypoint data, wherein each waypoint data includes at least two of a longitude, a latitude and an altitude of the land vehicle on the land;
a controller which generates a plurality of sample intervals, which acquires for each sample interval the waypoint data output by the GPS receiver and the land distance data output by the distance measuring instrument, and which relates for each sample interval the acquired waypoint data and land distance data; and
a memory coupled to the controller for storing for each sample interval the acquired waypoint data and land distance data.

12. The land surveying apparatus as set forth in claim 11, further including a radio beacon receiver, the radio beacon receiver configured to receive an error correction radio beacon signal and to output error correction data to the GPS receiver, the GPS receiver acquiring the error correction data output from the radio beacon receiver and combining the error correction data with the waypoint data from the received GPS signals to obtain corrected waypoint data corresponding to a position of the GPS receiver on the earth's surface.

13. The land surveying apparatus as set forth in claim 11, further including a display coupled to the controller, wherein the controller causes the display to display a map which includes, for each of one or more sample intervals, indicia corresponding to at least one of the waypoint data and land distance data for the sample interval, with each indicia located on the map as a function of the waypoint data for the sample interval.

14. The land surveying apparatus as set forth in claim 13, wherein each indicia displayed on the map is located at a position corresponding to an earth coordinate position determined from the waypoint data for the sample interval.

15. The land surveying apparatus as set forth in claim 13, wherein the map further includes at least one of the waypoint data and land distance data for the sample interval adjacent each of one or more of the corresponding indicia.

16. The land surveying apparatus as set forth in claim 11, wherein the controller generates a sample interval at least every one second.

17. The land surveying apparatus as set forth in claim 11, wherein the distance measuring instrument further outputs speed data regarding a measured speed the land vehicle is traveling on the land.

18. The land surveying apparatus as set forth in claim 11, further including a casing for housing the distance measuring instrument, the GPS receiver, the controller, the memory, a radio beacon receiver, and an alphanumeric display coupled to the controller.

19. The land surveying apparatus as set forth in claim 18, wherein the controller causes the alphanumeric display to display at least one of the distance the land vehicle travels and the speed of the land vehicle traveling on the land.

20. A method of land surveying comprising the steps of:
(a) providing a system including a distance measuring instrument (DMI) and a global positioning system (GPS) receiver connected to a controller;
(b) traveling along a path with the system;
(c) causing the controller to generate a plurality of sample intervals;
(d) acquiring for each sample interval earth position data output by the GPS receiver and land distance data output by the DMI;
(e) relating for each sample interval the acquired earth position data and acquired land distance data;
(f) storing in a memory coupled to the controller for each sample interval the acquired earth position data and the acquired land distance data; and
(g) displaying the stored earth position data and/or the stored land distance data output on a display coupled to the controller, wherein the controller causes the display to display a map that includes, for each of one or more sample intervals, indicia corresponding to at least one of the earth position data and land distance data for the sample interval, where each indicia displayed on the map is located at a map coordinate position corresponding to an earth coordinate position determined from the earth position data for the sample interval.
